(19) United States
(12) Patent Application Publication
(10) Pub. No.: US 2011/0157182 A1
(43) Pub. Date: Jun. 30, 2011

(54) Electronic Device and Adjusting Control Method of Projection Resolution Thereof

(75) Inventors: Chia-Hsun Wu, Taipei (TW); Chih-Wen Hsieh, Taipei (TW); Alejandro Zamudio Sanchez, Taipei (TW); Chia-Ying Lee, Taipei (TW)

(73) Assignee: PEGATRON CORPORATION, Taipei (TW)

(21) Appl. No.: 12/971,065

(22) Filed: Dec. 17, 2010

(30) Foreign Application Priority Data
Dec. 31, 2009 (TW) 098146519

(51) Int. Cl. G06T 17/00

(52) U.S. Cl. 345/428

(57) ABSTRACT

An electronic device includes an image output module and a button module. The image output module has a storage unit storing a resolution table, and the resolution table has a plurality of resolution. The button module outputs a resolution adjusting signal. The image output module outputs an image having predetermined resolution and adjusts resolution of the image after receiving the resolution adjusting signal. This invention also provides an adjusting control method of projection resolution.

### CROSS-REFERENCE TO RELATED APPLICATIONS

This Non-provisional application claims priority under 35 U.S.C. §119(a) on Patent Application No(s). 098146519 filed in Taiwan, Republic of China on Dec. 31, 2009, the entire contents of which are hereby incorporated by reference.

### BACKGROUND OF THE INVENTION

1. Field of the Invention

This invention relates to an electronic device and a control method thereof and, more particularly, to an electronic device and an adjusting control method of projection resolution thereof.

2. Description of the Related Art

To improve communication efficiency of conferences, projectors capable of easily projecting large-scale images have become the necessary video playing apparatus in business conferences. In various kinds of the conferences, the projector is mostly used to assist in displaying the large-scale images and to project various kinds of file data needed by a user, such that people participated in the conference clearly see contents of the file data cooperating with a speech.

Therefore, the user only needs to connect an electronic device, such as a notebook computer, with the projector, such that the content in the electronic device may be projected on a projecting screen via the projector. Thereby, the people participated in the conference clearly see the projecting content.

However, image resolution initially projected by the projector may not be the image resolution expected by the user. At that moment, to adjust the resolution, the user has to first access a resolution table built in the electronic device and then selects another resolution, and after the user presses an enter key, the resolution of the projected image may be changed to another resolution. In addition, if the changed image resolution is still not the one expected by the user, the above steps have to be repeated. After the resolution is changed to the one expected by the user, the user has to press the enter key again. Otherwise, the image resolution may be automatically changed to the original resolution.

### BRIEF SUMMARY OF THE INVENTION

According to the above, this invention is to provide an electronic device and an adjusting control method thereof capable of directly adjusting and instantly changing projection resolution.

The invention provides an adjusting control method of projection resolution for an electronic device connected with a projector. The electronic device has a button module. The adjusting control method includes the following steps. An image having predetermined resolution is projected. A resolution adjusting signal generated when a user operates the button module is sensed. Resolution of the projected image is adjusted according to the resolution adjusting signal.

The invention further provides an electronic device connected with a projector. The electronic device includes an image output module and a button module. The button module generates a resolution adjusting signal. The image output module outputs an image having predetermined resolution to the projector and adjusts resolution of the image after receiving the resolution adjusting signal.

In one embodiment of the invention, the button module may be a physical button module or a virtual button module.

In one embodiment of the invention, after the resolution of the image is adjusted, the image may display corresponding numerical data of the resolution.

To sum up, according to the electronic device and the adjusting control method of the projection resolution thereof in the invention, the user can press (such as pressing the physical button module) or click (such as clicking the virtual button module) the button module to directly adjust the predetermined resolution of the image to another resolution while the image does not display the resolution table. In other words, the user can directly adjust the resolution of the image via the button module and directly change the resolution of the image to different resolution. Thereby, the user can operate and use the electronic device more intuitively thus to improve convenience when the electronic device in the invention adjusts the projection resolution.

These and other features, aspects, and advantages of the present invention will become better understood with regard to the following description, appended claims, and accompanying drawings.

### BRIEF DESCRIPTION OF THE DRAWINGS

FIG. 1 is a block diagram showing an electronic device according to one preferred embodiment of the invention;

FIG. 2A and FIG. 2B are schematic diagrams showing different adjusting modes of projection resolution of an electronic device according to one preferred embodiment of the invention; and

FIG. 3 is a flowchart showing an adjusting control method of projection resolution according to one preferred embodiment of the invention.

### DETAILED DESCRIPTION OF THE INVENTION

An electronic device and an adjusting control method of projection resolution thereof in preferred embodiments of this invention are described hereinbelow according to related drawings, and the same elements are marked by the same reference numbers.

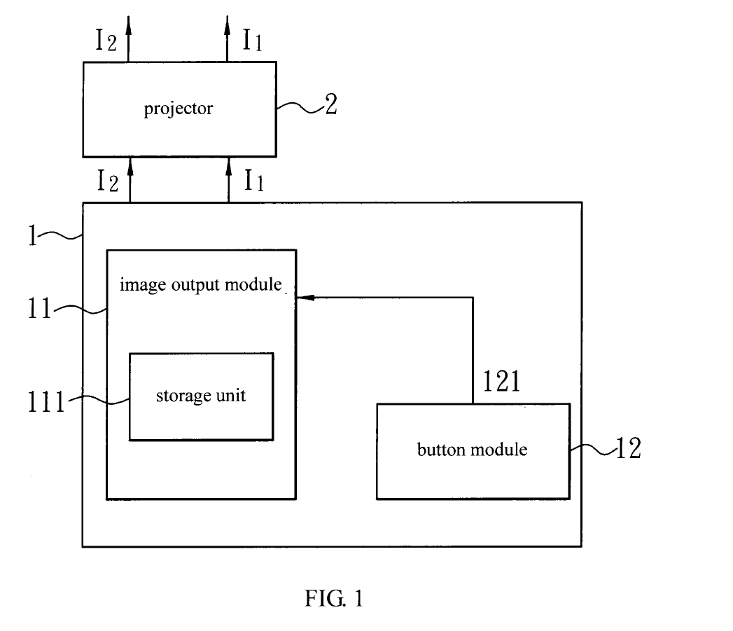

FIG. 1 is a block diagram showing an electronic device according to one preferred embodiment of the invention. In FIG. 1, an electronic device 1 may be a notebook computer, a desktop computer, or a video and audio playing device, and the electronic device 1 is connected with a projector 2. The electronic device 1 may be used for receiving a projector connecting signal. The electronic device 1 includes an image output module 11 and a button module 12.

The image output module 11 has a storage unit 111 storing a resolution table, and the resolution table has a plurality of resolutions. The resolutions may be 800×600, 1024×600, or 1024×768 and so on, and according to different needs, the resolution table can have more resolutions in different kinds. The image output module 11 may first output an image I₁ having one of the resolution as predetermined resolution to the projector 2. In other words, the image output module 11 may first output the image I₁ whose resolution is such as 800×600 to the projector 2, and the projector 2 projects the image I₁ having the above resolution. The above resolution is just taken for example, and the invention is not limited thereto.

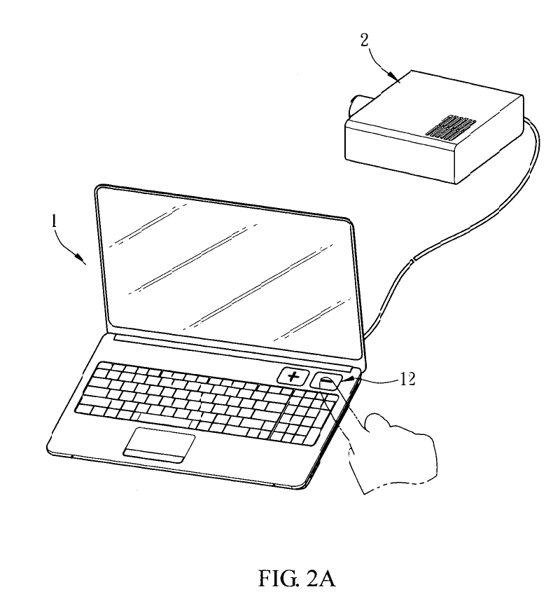

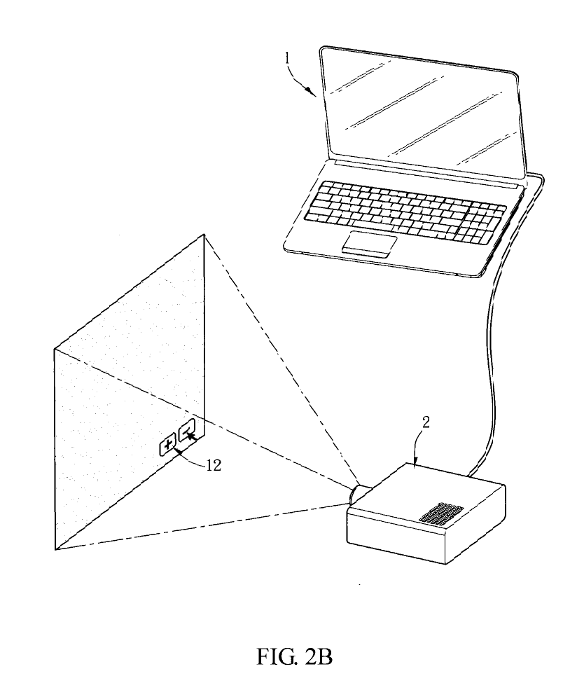

The button module 12 generates a resolution adjusting signal 121. The button module 12 may be a physical button module, as shown in FIG. 2A, or a virtual button module, as shown in FIG. 2B. In other words, a user may directly press the physical button module, or click the virtual button module via a cursor, and the button module 12 may sense the operation of the user to generate the resolution adjusting signal 121. In FIG. 2A and FIG. 2B, a notebook computer as the electronic device 1 is taken for example. However, the invention is not limited thereto.

Therefore, after the image output module 11 receives the resolution adjusting signal 121, the image output module 11 may directly adjust the above resolution, such as 800×600, of the image I₁ to another resolution, such as 1024×768, according to the resolution table while the image I₁ does not display the resolution table. The projector 2 may project an image I₂ having another resolution.

Thereby, the user may directly press the physical button module, as shown in FIG. 2A, or click the virtual button module, as shown in FIG. 2B, to adjust the predetermined resolution of the image of the electronic device 1 projected by the projector 2 to another resolution while the image I₁ does not display the resolution table. In other words, without accessing the resolution table built in the electronic device 1 and performing a series of confirming processes, the user can directly adjust the resolution of the image I₁ via the button module 12 and directly change the resolution of the image to different resolution. Thereby, the user can operate and use the electronic device 1 more intuitively thus to improve convenience when the electronic device 1 adjusts the projection resolution.

After the resolution of the image I₁ is directly adjusted to another resolution, the image I₁ displays corresponding numerical data of another resolution, such that the user can know the resolution after adjustment. The invention is not limited thereto.

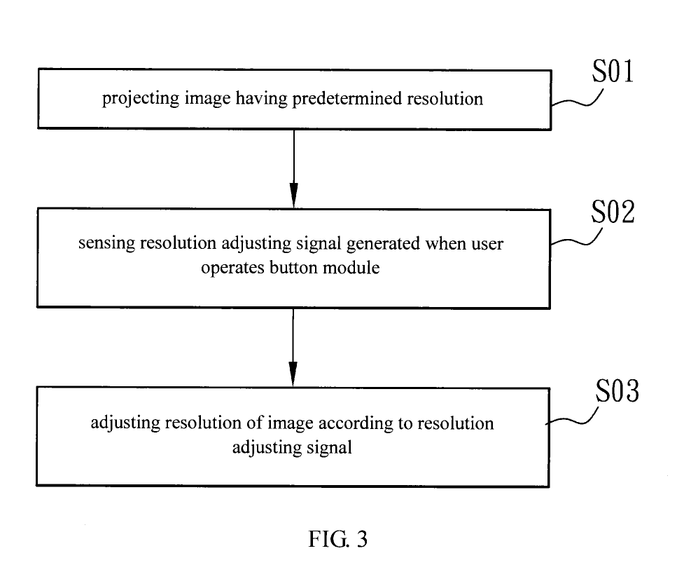

FIG. 3 is a flowchart showing an adjusting control method of projection resolution according to one preferred embodiment of the invention. In FIG. 3, the adjusting control method in the embodiment includes step S01 to step S03. In step S01, an image having predetermined resolution is projected. In step S02, a resolution adjusting signal generated when a user operates the button module is sensed. In step S03, resolution of the image is adjusted according to the resolution adjusting signal. In preferred embodiments of the invention, further comprising the following step that a projector connecting signal is received by the electronic device.

Since the adjusting control method of the projection resolution is described in detail in the embodiment as shown in FIG. 1, it is not described herein for a concise purpose.

To sum up, according to the electronic device and the adjusting control method of the projection resolution thereof in the embodiments of the invention, the user can press (such as pressing the physical button module) or click (such as clicking the virtual button module) the button module to directly adjust the predetermined resolution of the image to another resolution while the image may not display the resolution table. In other words, without accessing the resolution table built in the electronic device and performing a series of confirming processes, the user may directly adjust the resolution of the image via the button module and directly change the resolution of the image to different resolution. Thereby, the user may operate and use the electronic device more intuitively thus to improve the convenience when the electronic device in the embodiments of the invention adjusts the projection resolution.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An adjusting control method of projection resolution for an electronic device connected with a projector, the electronic device having a button module, the adjusting control method comprising the following steps of:
projecting an image having predetermined resolution;
sensing a resolution adjusting signal generated when a user operates the button module; and
adjusting resolution of the projected image according to the resolution adjusting signal.

2. The adjusting control method according to claim 1, further comprising the following step of:
directly adjusting the resolution of the image according to a resolution table by the resolution adjusting signal while the image does not display the resolution table.

3. The adjusting control method according to claim 1, further comprising the following step of:
receiving a projector connecting signal by the electronic device.

4. The adjusting control method according to claim 1, wherein the button module is a physical button module or a virtual button module.

5. The adjusting control method according to claim 1, wherein after the resolution of the image is adjusted, the image displays corresponding numerical data of the resolution.

6. An electronic device connected with a projector, comprising:
a button module generating a resolution adjusting signal; and
an image output module outputting an image having predetermined resolution to the projector and adjusting resolution of the image after receiving the resolution adjusting signal.

7. The electronic device according to claim 6, wherein the image output module has a storage unit storing a resolution table and directly adjusts the resolution of the image according to the resolution table while the image does not display the resolution table.

8. The electronic device according to claim 6, wherein the button module is a physical button module or a virtual button module.

9. The electronic device according to claim 6, wherein after the resolution of the image is adjusted, the image displays corresponding numerical data of the resolution.

10. The electronic device according to claim 6, wherein the projector projects the image.
